(19) United States
(12) Patent Application Publication
(10) Pub. No.: US 2026/0092552 A1
(43) Pub. Date: Apr. 2, 2026

(54) PRECHAMBER ELEMENT, IGNITING DEVICE AND METHOD FOR ASSEMBLING AN IGNITING DEVICE

(71) Applicant: DKT VERWALTUNGS-GMBH, Walldorf (DE)

(72) Inventors: Nicolas WIPPERMANN, Karlsruhe (DE); Steffen KUHNERT, Heidelberg (DE)

(73) Assignee: DKT VERWALTUNGS-GMBH, Walldorf (DE)

(21) Appl. No.: 19/110,705

(22) PCT Filed: Jul. 19, 2023
(86) PCT No.: PCT/DE2023/200150

§ 371 Date: Mar. 11, 2025

(30) Foreign Application Priority Data
Sep. 13, 2022 (DE) 10 2022 209 529.4

(51) Int. Cl. F02B 19/12; F02B 19/18; F02M 61/14

(52) U.S. Cl. CPC F02B 19/12; F02B 19/18; F02M 61/14; F02M 2200/855

(57) ABSTRACT

A prechamber element for an igniting device has a main body and a prechamber cover. The main body and the prechamber cover form a prechamber. The main body has an opening for receiving a spark plug and has a fastening portion for arrangement in an assembly channel of a cylinder head or a cylinder head sleeve. At least one overflow passage is formed on the main body and/or on the prechamber cover. At least one outlet opening of the at least one overflow passage lies at least partially outside a volume body that is described by a geometric extrusion of a smallest cross section of the assembly channel along a longitudinal axis of the assembly channel. An igniting device has a prechamber element and a cylinder head sleeve and/or a cylinder head.

### CROSS-REFERENCE TO RELATED APPLICATIONS

This application is a national stage application filed under 35 U.S.C. § 371 of PCT Application No. PCT/DE2023/200150, filed Jul. 19, 2023, which claims priority to German patent application DE 10 2022 209 529.4, filed Sep. 13, 2022, the entire disclosure of each of which is incorporated herein by reference.

### BACKGROUND OF THE DISCLOSURE

### 1. Field of the Disclosure

The disclosure relates to a prechamber element for an igniting device, having a main body and a prechamber cover, wherein the main body and the prechamber cover form a prechamber, wherein the main body has an opening for receiving a spark plug and has a fastening portion for arrangement in an assembly channel of a cylinder head or a cylinder head sleeve, and wherein at least one transfer passage is formed in the main body and/or in the prechamber cover.

Furthermore, the present disclosure relates to an igniting device having a prechamber element. In addition, the present disclosure relates to a method for assembling an igniting device.

### 2. Description of Related Art

Prechamber ignition is known in practice and ensures improved combustion of lean fuel-air mixtures in the case, for example, of spark-ignition engines. Purely by way of example, attention is drawn in this regard to EP 3 453 856 A1. This describes an igniting device having a cylinder head, a spark plug and a prechamber element (“support element”). The prechamber element is mounted in an assembly channel (“seat”) in the cylinder head and projects into the main combustion chamber. On the same side as the main combustion chamber, the prechamber element has a plurality of radially oriented transfer passages. The spark plug is inserted into an opening in the prechamber element on the side facing away from the main combustion chamber and thus closes off the prechamber within the prechamber element.

EP 2 977 586 A1 and US 2012/0103302 A1 each describe an igniting device having a prechamber element and a spark plug holder, which are connected to one another. The prechamber element is arranged in an assembly channel of a cylinder head. The spark plug holder is designed in such a way that a fuel injector can be inserted in addition to a spark plug.

Prechamber elements of known design are usually mounted in the center of the combustion chamber from the side of the cylinder head facing away from the main combustion chamber. This enables them to be replaced without having to disassemble the cylinder head. In the conventional form, the prechamber element cannot fall into the combustion chamber.

The problem with the known prechamber elements is that the design of the transfer passages and the ignition-flame profile which is achieved by this means do not ensure sufficiently good ignition and combustion of the fuel-air mixture. The dimensions of the prechamber element and thus the freedom of design for the arrangement of the transfer passages are furthermore limited by the minimum cross section of the assembly channel since the prechamber element has to pass through this channel during assembly.

### SUMMARY OF THE DISCLOSURE

It is therefore the underlying object of the present disclosure to configure and further develop a prechamber element of the type stated at the outset in such a way that improved ignition and combustion of the fuel-air mixture is achieved. The intention is furthermore to specify an igniting device and a method for assembling such an igniting device.

According to the disclosure, the abovementioned object is achieved by the features disclosed herein. Accordingly, a prechamber element of the type in question for an igniting device, having a main body and a prechamber cover, wherein the main body and the prechamber cover form a prechamber, wherein the main body has an opening for receiving a spark plug and has a fastening portion for arrangement in an assembly channel of a cylinder head or a cylinder head sleeve, and wherein at least one transfer passage is formed in the main body and/or in the prechamber cover, is characterized in that at least one outlet opening of the at least one transfer passage lies at least partially outside a three-dimensional body that is described by the geometric extrusion of a minimum cross section of the assembly channel along a longitudinal axis of the assembly channel.

According to the present disclosure, it has in the first instance been realized that the ignition and combustion properties are decisively determined by the spatial position of the ignition flames. The ignition flames pass via the transfer passages into the main combustion chamber and initiate combustion there. The outlet openings of the transfer passages are thus the starting points of combustion (ignition loci) in the main combustion chamber and have a decisive effect on flame propagation and the rate at which combustion takes place. Thus, they also have an effect on the efficiency of the process and on the formation of pollutants during combustion.

According to the disclosure, it has furthermore been realized that combustion in the main combustion chamber can be improved and accelerated in a simple manner by arranging the outlet openings further apart, in particular outside the minimum cross section of the assembly channel. This is achieved by making the area of the prechamber cover larger than the minimum cross section of the assembly channel. The prechamber element is then installed from the side of the cylinder head facing the main combustion chamber. The arrangement of the outlet openings of the transfer passages is thus independent of the minimum cross section of the assembly channel. As a result, as compared with the previous solutions, one or more outlet openings can be arranged significantly further apart and at least partially outside a three-dimensional body described by the virtual geometric extrusion of the minimum cross section of the assembly channel along the longitudinal axis of the assembly channel. This includes the case where a central point of at least one outlet opening lies outside this three-dimensional body.

The term “extrusion” in the context of this disclosure should be understood to correspond to its meaning in geometry, and it describes an increase in the dimensions of an element, e.g. of a plane surface. In this process, a three-dimensional body is formed by a parallel displacement of a surface along a line of theoretically arbitrary length. In this case, the surface is the minimum cross section, and in this case the line is the longitudinal axis of the assembly channel. Here, extrusion takes place virtually in both directions of the axis and by an unlimited length.

An assembly channel with a circular cross section and a center axis is considered below and therefore also relates to a prechamber element in which the maximum distance of the outlet opening of at least one transfer passage from the center axis of the assembly channel is greater than the minimum radius of the assembly channel.

As an advantageous option, the fastening portion of the main body of the prechamber element can have a region with a cylindrical lateral surface and/or a region with a conical lateral surface. The cylindrical lateral surface can be a lateral surface or part of a lateral surface of a general cylinder with an arbitrary base area. Furthermore, the cylinder can be a right cylinder or an oblique cylinder. In the case of an oblique cylinder, the line connecting the central points of the bases is not perpendicular to the bases. The conical lateral surface can be a lateral surface or part of a lateral surface of a cone with an arbitrary base area. Like the cylinder, the cone can be a right cone or an oblique cone. In the case of an oblique cylinder, the line connecting the apex of the cone and the central point of the base is not perpendicular to the base. The bases preferably have the shape of a circle or of an ellipse. By means of such a shape of the fastening portion, various fastening possibilities and, at the same time, a transitional region for widening the prechamber element in the direction of the prechamber cover can be obtained.

The prechamber cover can furthermore advantageously have a geometry that deviates from a circular shape. By means of an oval cover shape, it is possible to achieve a desired spacing of the outlet openings along a first, long semiaxis. At the same time, a prechamber element with a space-saving design can be achieved by means of a second, shorter semiaxis.

To improve the ignition behavior, it may be expedient to provide a fuel injector, which projects into the prechamber if appropriate. For this purpose, an additional opening for receiving a fuel injector can be formed in the main body.

The prechamber element is formed by the main body and the prechamber cover. This design can advantageously be of two-piece or one-piece configuration. In the case of two-piece configuration, the prechamber cover can be connected positively and/or nonpositively and/or materially to the main body. A welded joint is particularly suitable. One advantage of the two-piece configuration is the high degree of freedom of configuration in the design. Another advantage of the two-piece configuration is that different materials can be used for the main body and the prechamber cover. The main body can, for example, be produced from a material of high thermal conductivity, in particular at least 50 W/mK, preferably at least 100 W/mK (e.g. a copper alloy). As an alternative or in addition, the prechamber cover can, for example, be produced from a material of high thermal and chemical resistance (e.g. a nickel alloy). One-piece configuration of the prechamber element allows particularly simple and thus low-cost production since it is possible to dispense with expensive joining of the individual parts. In particular, the prechamber element can be produced by means of a forming process, which is preferably a matter of extrusion or deep drawing.

Depending on the design configuration of the engine, it may be advantageous for the assembly channel or the main body, which is arranged at least partially in the assembly channel, to be arranged eccentrically with respect to the prechamber cover. The main body then has a region with the lateral surface of an oblique truncated cone, for example. Alternatively, the prechamber cover may, for example, also be arranged eccentrically with respect to a main body which has regions with right cylindrical and/or conical lateral surfaces.

In order to improve the ignition and combustion behavior, the central points of at least two outlet openings can furthermore lie on a common circle or a common ellipse. By means of such an arrangement of the outlet openings, advantageous, uniform combustion in the main combustion chamber is achieved.

The underlying object is furthermore achieved by an igniting device having the features discussed herein. This igniting device has a prechamber element and a cylinder head sleeve and/or a cylinder head, wherein an assembly channel is formed in the cylinder head sleeve or the cylinder head, wherein the fastening portion of the prechamber element is arranged in the assembly channel.

According to the disclosure, it has been realized that the prechamber element can be arranged and fastened as a single component in an assembly channel of a cylinder head. The prechamber element is then installed from the side of the main combustion chamber. During maintenance work, e.g. changing of the spark plugs, the prechamber element can remain in the cylinder head and does not have to be removed. The prechamber element can advantageously be arranged and fastened in a cylinder head sleeve, which in turn is arranged in the cylinder head. This allows installation and removal of the prechamber element from the side of the cylinder head facing away from the main combustion chamber. The cylinder head does not have to be removed during this process. In addition, a cylinder head sleeve enables simple conversion of the cylinder head for use of the prechamber element in question.

The assembly channel advantageously has a minimum cross section for receiving the fastening portion. Part of the assembly channel in which the fastening portion is arranged can be of cylindrical design, being formed by a drill hole for example. In this case, the assembly channel has the minimum cross section in this part.

The fastening portion can furthermore advantageously be used to fasten the prechamber element in the assembly channel positively and/or nonpositively and/or materially. A screwed or shrink-fit joint is advantageous, for example, when the fastening portion has a region with a cylindrical lateral surface. In the case of a screwed joint, an external thread can be arranged in this region and an internal thread can be arranged on the corresponding inner surface of the assembly channel. If the fastening portion has a region with a conical lateral surface, the implementation of a conical joint may be advantageous, for example. Furthermore, the prechamber element can be fastened in the assembly channel with the aid of a clamped joint, for example.

In addition, a spark plug and/or a fuel injector can furthermore advantageously be provided. In this case, the spark plug and/or fuel injector project/s at least partially into the prechamber element through the opening provided in the main body. The spark plug enables the fuel-air mixture in the prechamber to be ignited. The spark plug can be a spark plug of a conventional type without a prechamber, for example. These are generally more advantageous than prechamber spark plugs and can thus reduce maintenance costs. It is furthermore conceivable, for example, for the prechamber element to serve as a ground electrode of a suitable spark plug. An additional fuel injector may further improve ignition.

The spark plug and/or the fuel injector can be fastened in the prechamber element positively and/or nonpositively and/or materially. For this purpose, screwed joints are suitable, in particular. A screwed joint offers the advantage that the connection is releasable and thus enables easy exchange of the spark plug or of the fuel injector. A clamped or conical joint allows particularly quick assembly. A shrink-fit joint is furthermore conceivable.

The prechamber element according to the present disclosure or the igniting device according to the disclosure is suitable for use with a stationary gas engine, for example. Use in a nonstationary spark-ignition engine is furthermore conceivable, namely by virtue of the ignition properties achieved through the arrangement of the transfer passages. However, use is not restricted to the abovementioned types of engine but is also conceivable with other suitable engines.

The underlying object is furthermore achieved by a method for producing and assembling the igniting device having the features discussed herein. The method for assembling an igniting device, in particular an igniting device, comprises the following method steps:
inserting a prechamber element into an assembly channel of a cylinder head from a side of the cylinder head facing a main combustion chamber or into an assembly channel of a cylinder head sleeve before or after the insertion of the cylinder head sleeve into the cylinder head,
if appropriate inserting a spark plug and/or a fuel injector into the prechamber element.

As regards the assembly of the igniting device, it has been realized according to the disclosure that the above-described design of the prechamber element and of the assembly channel enables the prechamber element to be inserted into the assembly channel of the cylinder head only from the side of the cylinder head facing the main combustion chamber. In the course of the assembly of the igniting device, the prechamber element is therefore first of all inserted into the assembly channel of the cylinder head. In the case where a cylinder head sleeve is used, the prechamber element can be inserted into the assembly channel of the cylinder head sleeve before or after the cylinder head sleeve is or has been inserted into the cylinder head. Insertion of the cylinder head sleeve into the cylinder head can take place from the side of the cylinder head facing or facing away from the main combustion chamber. If the igniting device additionally has a spark plug and/or a fuel injector, these can then be inserted into the prechamber element from the side of the cylinder head facing away from the main combustion chamber.

### BRIEF DESCRIPTION OF THE DRAWINGS

There are now various possibilities of configuring and further developing the teaching of the present disclosure in an advantageous manner. For this purpose, reference may be made, on the one hand, to the claims that follow the additional independent claims and, on the other hand, to the following explanation of preferred exemplary embodiments of the disclosure with reference to the drawing. Preferred configurations and further developments of the teaching are also explained in general in conjunction with the explanation of the preferred exemplary embodiments of the disclosure with reference to the drawing.

FIG. 1 shows a first exemplary embodiment of an igniting device according to the invention having a prechamber element according to the disclosure in a schematic sectioned illustration.

FIG. 2 shows another exemplary embodiment of an igniting device according to the invention having a prechamber element according to the disclosure in a schematic sectioned illustration.

FIG. 3 shows another exemplary embodiment of an igniting device according to the invention having a prechamber element according to the disclosure in a schematic sectioned illustration.

FIG. 3 shows another exemplary embodiment of an igniting device according to the disclosure having a prechamber element according to the invention in a schematic sectioned illustration.

FIG. 4 shows another exemplary embodiment of an igniting device according to the disclosure having a prechamber element according to the invention in a schematic sectioned illustration.

FIG. 5 shows another exemplary embodiment of an igniting device according to the disclosure having a prechamber element according to the invention in a schematic sectioned illustration.

FIG. 6 shows another exemplary embodiment of an igniting device according to the invention having a prechamber element according to the disclosure in a schematic sectioned illustration.

### DETAILED DESCRIPTION OF THE DISCLOSURE

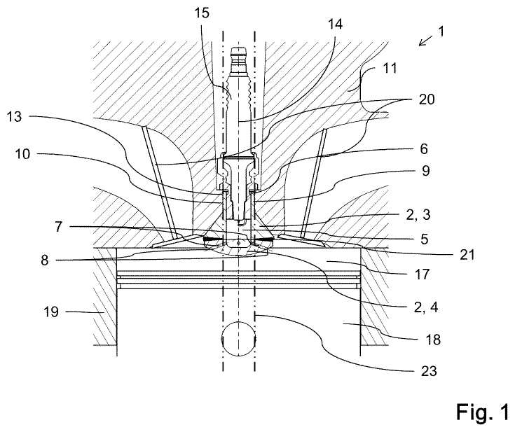

A first exemplary embodiment of an igniting device 1 according to the disclosure is illustrated in FIG. 1. The igniting device 1 is arranged in an engine having a cylinder 19, a piston 18 and engine valves 20. The igniting device 1 comprises a prechamber element 2 according to the invention, into which a spark plug 15 is inserted, and a cylinder head 11. Here, the spark plug 15 is designed as a conventional spark plug with a wire ground electrode. However, attention is expressly drawn to the fact that other forms of embodiment of the spark plug 15 are also possible. The prechamber element 2 is secured in an assembly channel 10 in the cylinder head 11 and projects partially into the main combustion chamber 17. In this exemplary embodiment of the igniting device 1, the prechamber element 2 is inserted from the side of the cylinder head 11 facing the main combustion chamber 17.

The prechamber element 2 has a main body 3 with an opening 6 for receiving the spark plug 15, and a prechamber cover 4. These form a prechamber 5. The prechamber cover 4 is connected to the main body 3 by a weld seam 21. Radially extending transfer passages 7 with outlet openings 8 toward the main combustion chamber 17 are arranged in the prechamber cover 4.

The fastening portion 9 has a region with a cylindrical lateral surface and a circular cross section and a region with a conical lateral surface. This conical region forms the transition from the cylindrical part of the main body 3 to the prechamber cover 4. In this exemplary embodiment, the fastening of the prechamber element 2 in the assembly channel 10 via the fastening portion 9 is implemented by means of a shrink-fit joint.

In the exemplary embodiment, the assembly channel 10 has a minimum cross section 13 in the region of the cylindrical part of the main body 3. A virtual three-dimensional body 23 in the form of a cylinder can be described by geometric extrusion of this minimum cross section 13 along a longitudinal axis 14 of the assembly channel 10. In this exemplary embodiment, all the outlet openings 8 of the transfer passages 7 lie outside this three-dimensional body 23.

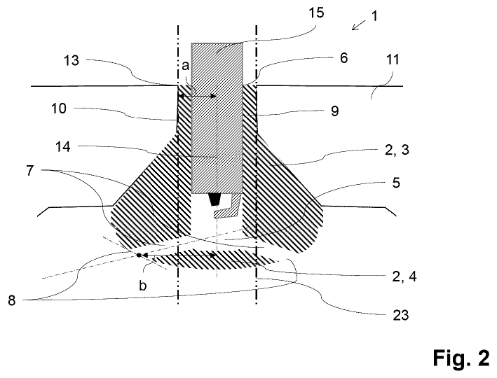

FIG. 2 shows another exemplary embodiment of an igniting device 1 according to the disclosure with a prechamber element 2, a spark plug 15 and a cylinder head 11. In this case, the prechamber element 2 is of one-piece design. Adjoining the cylindrical region of the fastening portion 9 and the prechamber cover 4, the assembly channel 10 furthermore has a circular shape. In this exemplary embodiment, the central point of the outlet opening 8 of at least one transfer passage 7 lies outside a three-dimensional body 23 described by the extrusion of the minimum cross section 13 along the longitudinal axis 14 of the assembly channel 10. In this case, the three-dimensional body 23 has the shape of a cylinder with the radius a.

In other words, the distance b between the central point of the outlet opening 8 of at least one transfer passage 7 and the center axis of the assembly channel 10 is in this case greater than the smallest radius a of the assembly channel 10.

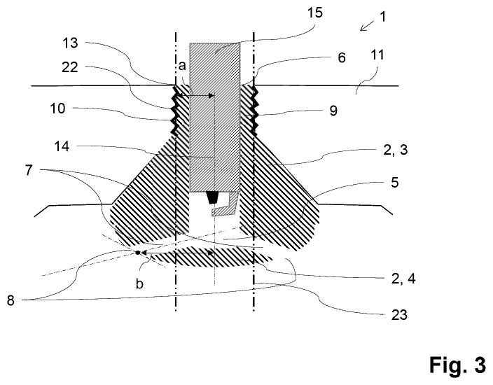

FIG. 3 furthermore shows an exemplary embodiment of an igniting device 1 according to the disclosure with a prechamber element 2, a spark plug 15 and a cylinder head 11. As in FIG. 2, the assembly channel 10 and the prechamber cover 4 have a circular shape. In this exemplary embodiment, the fastening of the prechamber element 2 in the assembly channel 10 is implemented by means of a screwed joint. The fastening portion 9 has an external thread 22 in the region with a cylindrical lateral surface. A corresponding internal thread is arranged in the assembly channel 10 in this region. In this exemplary embodiment too, the outlet openings 8 lie outside the virtual three-dimensional body 23.

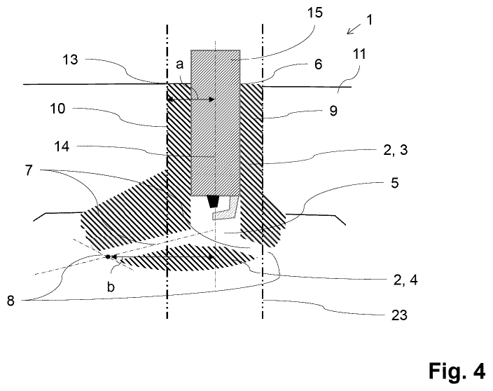

FIG. 4 shows another exemplary embodiment. The illustrated igniting device 1 according to the disclosure has a prechamber element 2, a spark plug 15 and a cylinder head 11, wherein the prechamber cover 4 and the main body 3 are arranged eccentrically with respect to one another. Here, the main body 3 has regions with the lateral surface of an oblique truncated cone and of a right cylinder, in each case with circular bases. The prechamber cover 4 has a circular shape. The central axes of the cylindrical portion of the main body 3 and of the prechamber cover 4 are thus arranged offset with respect to one another. The region of the main body 3 with the conical lateral surface acts as a transitional region between the cylindrical portion of the main body 3 and the prechamber cover 4. The outlet openings 8 lie at least partially (right-hand outlet opening 8 in the sectioned illustration) or completely (left-hand outlet opening 8 in the sectioned illustration) outside the virtual three-dimensional body 23.

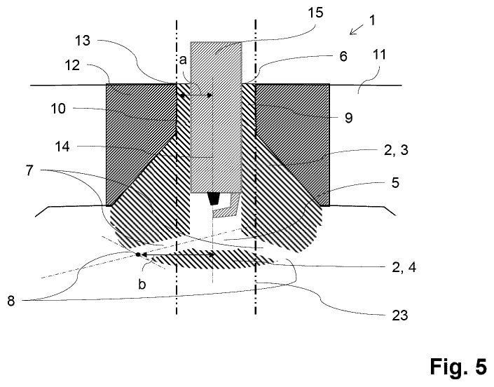

FIG. 5 illustrates another exemplary embodiment of an igniting device 1 according to the present disclosure with a prechamber element 2 according to the invention as per FIG. 2, a cylinder head sleeve 12, a spark plug 15 and a cylinder head 11. The cylinder head sleeve 12 has the assembly channel 10 for the arrangement of the prechamber element 2 and is arranged in the cylinder head 11. It can be seen that the cylinder head sleeve 12 can be inserted from the side of the cylinder head 11 facing away from or facing the main combustion chamber 17. The virtual three-dimensional body 23 is formed by extrusion of the minimum cross section 13 of the assembly channel 10, wherein in this case the channel is arranged in the cylinder head sleeve 12. The outlet openings 8 thus lie outside the virtual three-dimensional body 23.

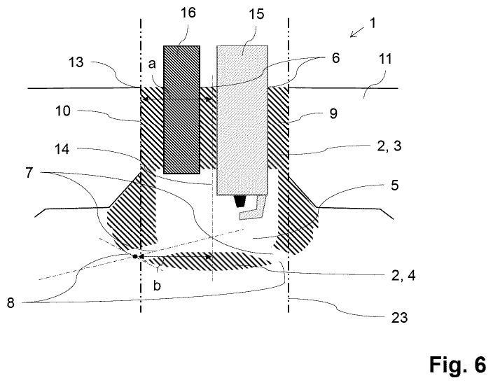

FIG. 6 shows another exemplary embodiment of an igniting device 1 according to the disclosure. Apart from a spark plug 15, a fuel injector 16 is additionally arranged in the prechamber element 2, projecting into the prechamber 5. As in FIG. 2, the assembly channel 10 and the prechamber cover 4 have a circular shape. The main body 3 of the prechamber element 2 in each case has an opening 6 for receiving the spark plug 15 and the fuel injector 16. In this exemplary embodiment, the outlet openings 8 lie at least partially outside the virtual three-dimensional body 23.

To avoid repetitions, attention is drawn, in respect of further advantageous configurations of the device according to the disclosure, to the general part of the description and to the appended claims.

Finally, it should expressly be pointed out that the above-described exemplary embodiments of the device according to the invention serve merely to explain the claimed teaching but do not restrict it to the exemplary embodiments.

### LIST OF REFERENCE SIGNS

1 igniting device
2 prechamber element
3 main body
4 prechamber cover
5 prechamber
6 opening
7 transfer passage
8 outlet opening
9 fastening portion
10 assembly channel
11 cylinder head
12 cylinder head sleeve
13 minimum cross section
14 longitudinal axis
15 spark plug
16 fuel injector
17 main combustion chamber
18 piston
19 cylinder
20 engine valve
21 weld seam
22 external thread
23 virtual three-dimensional body

1. A prechamber element for an igniting device comprising:
a main body;
a prechamber cover that together with the main body defines a prechamber,
wherein the main body has an opening configured to receive a spark plug,
wherein the main body has a fastening portion for arrangement in an assembly channel of a cylinder head or a cylinder head sleeve, and
wherein at least one transfer passage is formed in the main body and/or in the prechamber cover; and
at least one outlet opening of the at least one transfer passage is positioned at least partially outside a three-dimensional body that is defined by a geometric extrusion of a minimum cross section of the assembly channel along a longitudinal axis of the assembly channel.

2. The prechamber element according to claim 1, wherein the at least one outlet opening has a central point positioned outside the three-dimensional body.

3. The prechamber element according to claim 1, wherein the fastening portion has a region with a cylindrical lateral surface and/or a region with a conical lateral surface.

4. The prechamber element according to claim 1, wherein the prechamber cover has a geometry that deviates from a circular shape.

5. The prechamber element according to claim 1, further comprising an opening formed in the main body for receiving a fuel injector.

6. The prechamber element according to claim 1,
wherein the main body and the prechamber cover are integrally formed as a single piece, or
wherein the main body and the prechamber cover are joined to each other through a positive connection, a non-positive connection, a material bond, or any combination thereof.

7. The prechamber element according to claim 1, wherein the main body and the prechamber cover are arranged eccentrically with respect to one another.

8. The prechamber element according to claim 1, further comprising a second outlet opening having a central point, wherein the central points of the at least one and second outlet openings lie on a common circle or a common ellipse.

9. An igniting device comprising:
a prechamber element having a main body and a prechamber cover that together with the main body defines a prechamber,
wherein the main body has an opening configured to receive a spark plug, wherein the main body has a fastening portion for arrangement in an assembly channel of a cylinder head or a cylinder head sleeve, and
wherein at least one transfer passage is formed in the main body and/or in the prechamber cover;
at least one outlet opening of the at least one transfer passage is positioned at least partially outside a three-dimensional body that is defined by a geometric extrusion of a minimum cross section of the assembly channel along a longitudinal axis of the assembly channel;
a cylinder head sleeve and/or a cylinder head; and
an assembly channel formed in the cylinder head sleeve or the cylinder head,
wherein the fastening portion of the prechamber element is arranged in the assembly channel.

10. The igniting device according to claim 9, wherein the assembly channel has a minimum cross section for receiving the fastening portion.

11. The igniting device according to claim 10, wherein the fastening portion fastens the prechamber element in the assembly channel by positive connection, a non-positive connection, or a material bond.

12. The igniting device according to claim 9, further comprising a spark plug and/or a fuel injector.

13. The igniting device according to claim 12, wherein the spark plug and/or the fuel injector fastened in the prechamber element by a positive connection, a non-positive connection, or a material bond.

14. A method for assembling an igniting device, the method comprising:
inserting a prechamber element into an assembly channel of a cylinder head from a side of the cylinder head facing a main combustion chamber or into an assembly channel of a cylinder head sleeve before or after the insertion of the cylinder head sleeve into the cylinder head.

15. The method according to claim 14, further comprising:
inserting a spark plug and/or a fuel injector into the prechamber element.

16. The method according to claim 14,
wherein the prechamber element comprises a main body and a prechamber cover that together with the main body defines a prechamber,
wherein the main body has an opening configured to receive a spark plug,
wherein the main body has a fastening portion for arrangement in an assembly channel of a cylinder head or a cylinder head sleeve,
wherein at least one transfer passage is formed in the main body and/or in the prechamber cover, and
wherein the at least one transfer passage has at least one outlet opening that is positioned at least partially outside a three-dimensional body that is defined by a geometric extrusion of a minimum cross section of the assembly channel along a longitudinal axis of the assembly channel.

17. The prechamber element according to claim 1, wherein the main body and the prechamber cover are joined to each other by a weld.

18. The prechamber element according to claim 1, wherein the prechamber cover has an ovular geometry.

19. The igniting device according to claim 10, wherein the fastening portion fastens the prechamber element in the assembly channel by at least one joint selected from the group consisting of: a screwed joint, a shrink-fit joint, a clamped joint, and a conical joint.

20. The igniting device according to claim 12, wherein the spark plug and/or the fuel injector is fastened in the prechamber element by at least one joint selected from the group consisting of: a screwed joint, a shrink-fit joint, a clamped joint, and a conical joint.
